(19) United States
(12) Patent Application Publication
(10) Pub. No.: US 2026/0000968 A1
(43) Pub. Date: Jan. 1, 2026

(54) POOLED-LETTER WORD PUZZLE WITH CUSTOMIZABLE DIFFICULTY

(71) Applicant: Thomas Cross Richardson, Huntington Beach, CA (US)

(72) Inventor: Thomas Cross Richardson, Huntington Beach, CA (US)

(21) Appl. No.: 18/760,937

(22) Filed: Jul. 1, 2024

(51) Int. Cl. A63F 9/00; A63F 13/5375; A63F 13/80

(52) U.S. Cl. CPC A63F 9/0098; A63F 13/5375; A63F 13/80

(57) ABSTRACT

A word puzzle having a customizable difficulty is provided. The puzzle has multiple letter pools to which the letters of the alphabet are assigned. The puzzle has multiple answer slots that are arranged along a horizontal line and correspond to the different letters of a desired multi-word solution to the puzzle. The puzzle has indicator icons aligned with the answer slots to indicate from which letter pool the puzzle solver should select the letter to fill that answer slot of the solution. The solution of the puzzle will reveal a passage, adage, saying or saw when the puzzle solver has correctly entered the letters into the answer slots of the puzzle.

### BACKGROUND

People enjoy the mental stimulation of word puzzles. Some word puzzles may require a great deal of mental focus to solve, while other word puzzles are best solved by allowing the mind to wander. A word puzzle such as a crossword puzzle or a word jumble can be made more challenging by using obscure words and clues. Alternately, word puzzles can be made less challenging by using more common words and clues. Some word puzzles employ an overlying puzzle theme to help the puzzle solver make connections between puzzle clues. Often solving a word puzzle can impart to the puzzle solver a different appreciation of word meanings or of relationships between words used in the puzzle. What is needed is a word puzzle that is fun to solve while broadening the mind of the person who is solving the puzzle.

### SUMMARY

Disclosed herein are embodiments of a word puzzle. In some aspects, the word can include a display tableau upon which is displayed a puzzle-key field, a user-input field, and an input-indicator field. The user-input field has a plurality of answer slots that are arrayed horizontally with one another. The input-indicator field has a corresponding plurality of indicator slots arrayed horizontally with one another, with each of the indicator slots being vertically aligned with an answer slot.

In some aspects, the word puzzle can include an instruction field that informs the puzzle solver of the method the puzzle solver must use to solve the puzzle. In some aspects, the instruction field can inform the puzzle solver that the solution or answer to the puzzle will be a proverb, an adage, a saying, or a saw. In certain arrangements, the word puzzle can include a given letter that is pre-filled into the input field. In some aspects, the word puzzle can include a clue directed to the puzzle solution indicated by the answer slots of the user-input field. In certain variants, the word puzzle can include a wildcard indicator associated with one or more answer slots of the input field. In some arrangements, the word puzzle can include a difficulty rating that informs the puzzle solver of the difficulty rating of the puzzle. In certain variants, the word puzzle can include a score field that informs the puzzle solver of a correlation between a time taken to solve the puzzle and a score corresponding to that time.

In some aspects, a method of creating the word puzzle is disclosed. In some arrangements the method can include one or more of the following steps: defining a plurality of letter pools, providing a string of answer slots corresponding to the letters and words in the solution to the puzzle, providing one or more indicator icons to indicate from which letter pool the puzzle solver must select the character for filling in the corresponding answer slot.

### BRIEF DESCRIPTION OF THE DRAWINGS

Embodiments of the present disclosure will now be described hereinafter, by way of example only, with reference to the accompanying drawings in which:

FIG. 1 illustrates a word puzzle, according to some aspects of the present disclosure.

FIG. 2A illustrates a word puzzle, according to some aspects of the present disclosure.

FIG. 2B illustrates a word puzzle, according to some aspects of the present disclosure.

FIG. 2C illustrates a word puzzle, according to some aspects of the present disclosure.

FIG. 2D illustrates a word puzzle, according to some aspects of the present disclosure.

FIG. 2E illustrates a word puzzle, according to some aspects of the present disclosure.

FIG. 2F illustrates a word puzzle, according to some aspects of the present disclosure.

FIG. 2G illustrates a word puzzle, according to some aspects of the present disclosure.

FIG. 2H illustrates a word puzzle, according to some aspects of the present disclosure.

FIG. 3 illustrates a word puzzle, according to some aspects of the present disclosure.

FIG. 4 illustrates a method of displaying a word puzzle, according to some aspects of the present disclosure.

FIG. 5 illustrates a method of creating a word puzzle, according to some aspects of the present disclosure.

### DETAILED DESCRIPTION

### Overview

This disclosure relates generally to a pooled-letter word puzzle, and to methods of displaying, and of creating, a pooled-letter word puzzle. In some aspects, the word puzzle disclosed herein can present to the puzzle solver a solution field that includes a plurality of horizontally-aligned character-answer slots and intervening spaces to indicate to the puzzle solver the number of words in the puzzle solution and the number of letters in each word of the puzzle solution. In some aspects, the puzzle solver is tasked with filling in the appropriate alphabetic character into each of the horizontally-aligned character-answer slots to achieve the puzzle's solution. To assist the puzzle solver in the task of determining the correct alphabetic character to enter for each answer slot, the puzzle of the present disclosure can further display an indicator icon associated with each character-answer slot. In some aspects, the indicator icon can indicate a pool of two or more letters from which the puzzle solver is to select the appropriate alphabetic character to enter into the character-answer slot that is associated with a particular indicator icon. For example, an indicator icon shaped like a hexagon may refer to a pool of the letters consisting of the four letters: “E”, “Z”, “R”, and “U”. Continuing with this non-limiting example, an answer slot associated with the hexagon-shaped indicator icon would indicate to the puzzle solver that the correct character for that character-answer slot must be one of the four letters: “E”, “Z”, “R”, or “U”.

In some aspects, the puzzle solution can be a proverb, an adage, a saying, or a saw that is revealed to the puzzle solver upon the puzzle solver correctly entering for each answer slot the proper alphabetic character for the puzzle's solution. In some arrangements, the word puzzle can include a title field that provides to the puzzle solver a reminder that the puzzle's solution will be a proverb, adage, saying, or saw. In some configurations, the title field can include a puzzle title or a puzzle brand. In some arrangements, the puzzle title or the puzzle brand can include the word “pass” or a derivation of the word “pass” (e.g., “passwords”) to remind the puzzle solver that the puzzle solution will be a Proverb, Adage, Saying, or Saw (PASS). In some configurations, the puzzle title or the puzzle brand can include the word “pass” displayed as an abbreviation with spacing (e.g., P. A. S. S.) or an abbreviation without spacing (e.g., P.A.S.S.).

In some configurations, the pooled-letter word puzzle can be customizable in puzzle difficulty. As described herein, the puzzle can include given letters or clues or both to assist the puzzle solver in figuring out the puzzle's solution. The puzzle difficulty can be increased by reducing the number of given letters or by making the clues more obscure. In some arrangements, the puzzle difficulty can be increased by reducing the number of indicator icons. For example, the number of indicator icons can be reduced by reducing the number of letter pools to which the alphabetic characters are distributed (e.g., increasing the number of alphabetic characters within one or more letter pools). Additionally and alternatively, the number of indicator icons can be reduced by using one indicator icon to refer to multiple letter pools. For example, using the indicator icon “2n” to refer to an “even-numbered” letter pool (e.g., 2, 4, 6) gives the puzzle solver less information (and increases the difficulty of the puzzle) compared to providing the puzzle solver an indicator icon that refers directly to which one of the “even-numbered” letter pool contains the correct alphabetic character for the associated answer slot of the puzzle's solution.

### Puzzle Layout

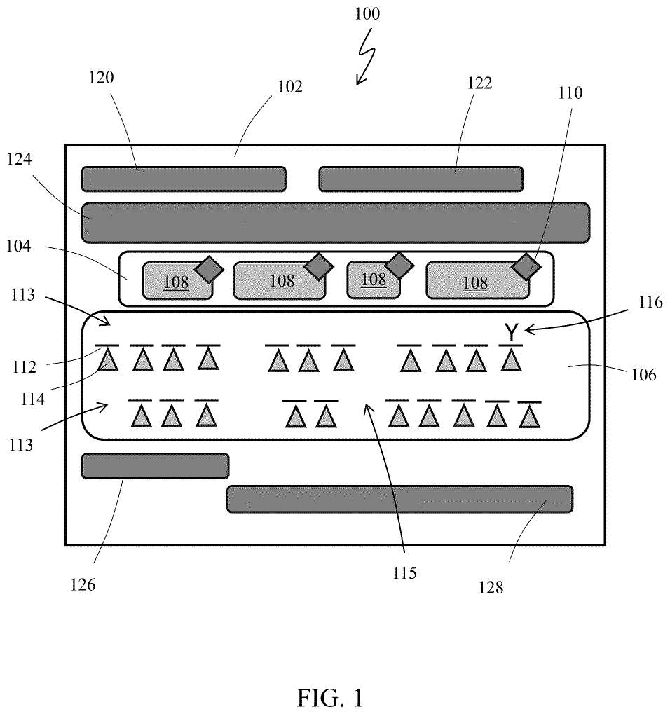

FIG. 1 depicts an illustrative, non-limiting example of a pooled-letter word puzzle 100, according to some aspects of the present disclosure. FIG. 1 illustrates the puzzle 100 can include a display tableau 102 on which is displayed a plurality of different puzzle fields, as described herein. In some configurations, the display tableau 102 can be a piece of paper such as, for example, a newspaper, a magazine, a book, or a restaurant menu. In some aspects, displaying the puzzle fields onto the display tableau 102 can be accomplished by printing (e.g., ink printing, laser-jet printing, lithography printing, silk-screen printing) the puzzle fields onto a display tableau 102 made of paper (e.g., a newspaper, a magazine, a book, a restaurant menu). In some arrangements, the display tableau 102 can be a display screen of a computer such as, for example, a mobile phone, a laptop computer, a desktop computer, a tablet. In some aspects, displaying the puzzle fields onto the display tableau 102 can be performed by illuminating a computer display screen to render an image of the puzzle fields on the computer display screen.

With continued reference to FIG. 1, the puzzle 100 can include a puzzle-key field 104 and a puzzle-solution field 106. In some aspects, the puzzle-key field 104 can include a plurality of letter pools 108, with each of the letter pools 108 having a unique pool identifier 110. In some arrangements, each letter of the alphabet is distributed to only one of the letter pools 108 such that each letter of the alphabet corresponds to only one pool identifier 110. In some arrangements, the difficulty of the puzzle 100 can be increased by allowing some of the letters of the alphabet to appear in more than one letter pool 108. Said another way, in some arrangements one or more letters of the alphabet may correspond individually to more than one pool identifiers 110. As described herein, the difficulty of the puzzle 100 can be customized by varying the number, size, or composition of the letter pools 108.

The puzzle-solution field 106 can include a plurality of character-answer slots 112. In some aspects, the answer slots 112 can be aligned horizontally with one another to form a string 113. The answer slots 112 in the string 113 can be separated from one another by a space slot 115. In some aspects, the space slot 115 can inform the puzzle solver of the number of words in the solution to the puzzle 100 (e.g., the passage, adage, saying, or saw that is revealed by correctly filling each answer slot 112 of the strings 113) and can inform the puzzle solver of the number of characters in each of those words. For example, the string 113 on the top line of the puzzle-solution field 106 of FIG. 1 shows eleven answer slots 112 and two space slots 115 that indicate to the puzzle solver that the number of letters in the first three words of the solution to the puzzle 100, reading from left to right, are as follows: the first and third words each have four letters and the second word has three letters.

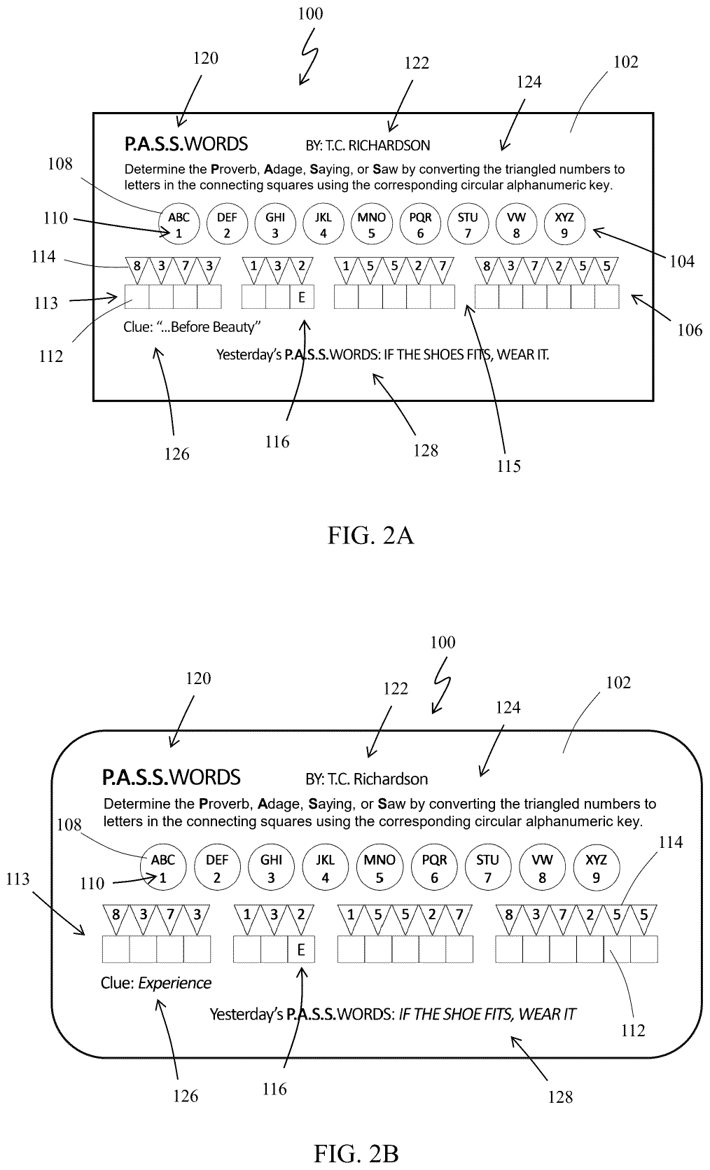

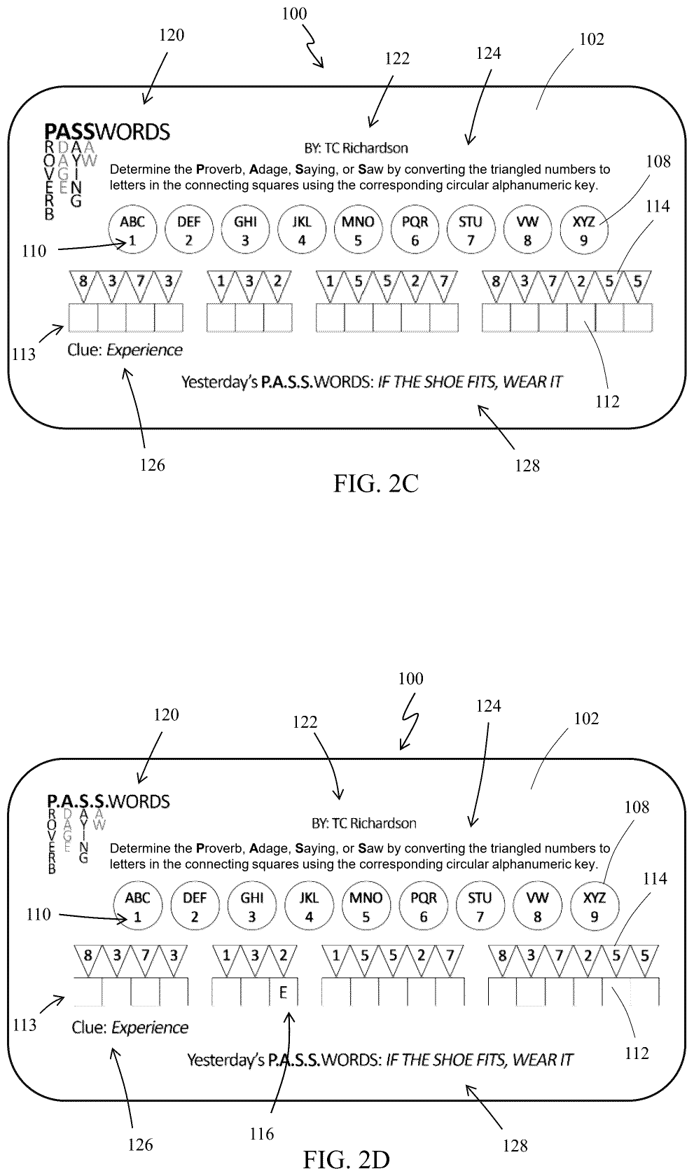

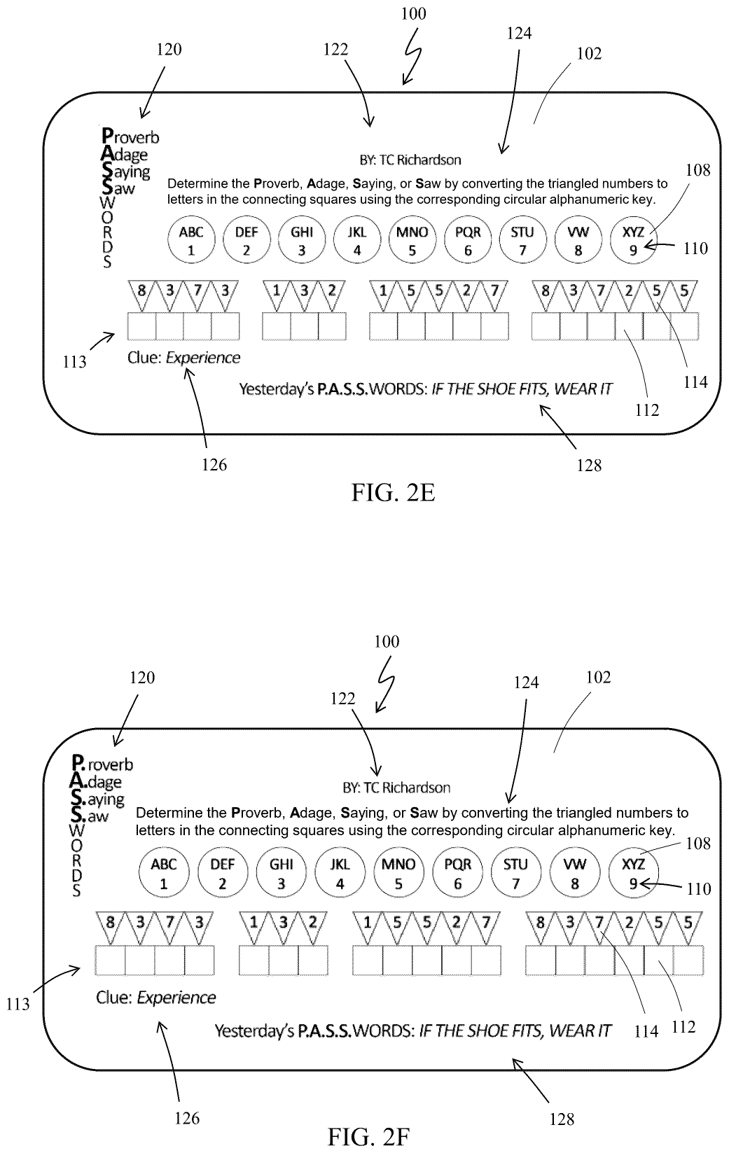

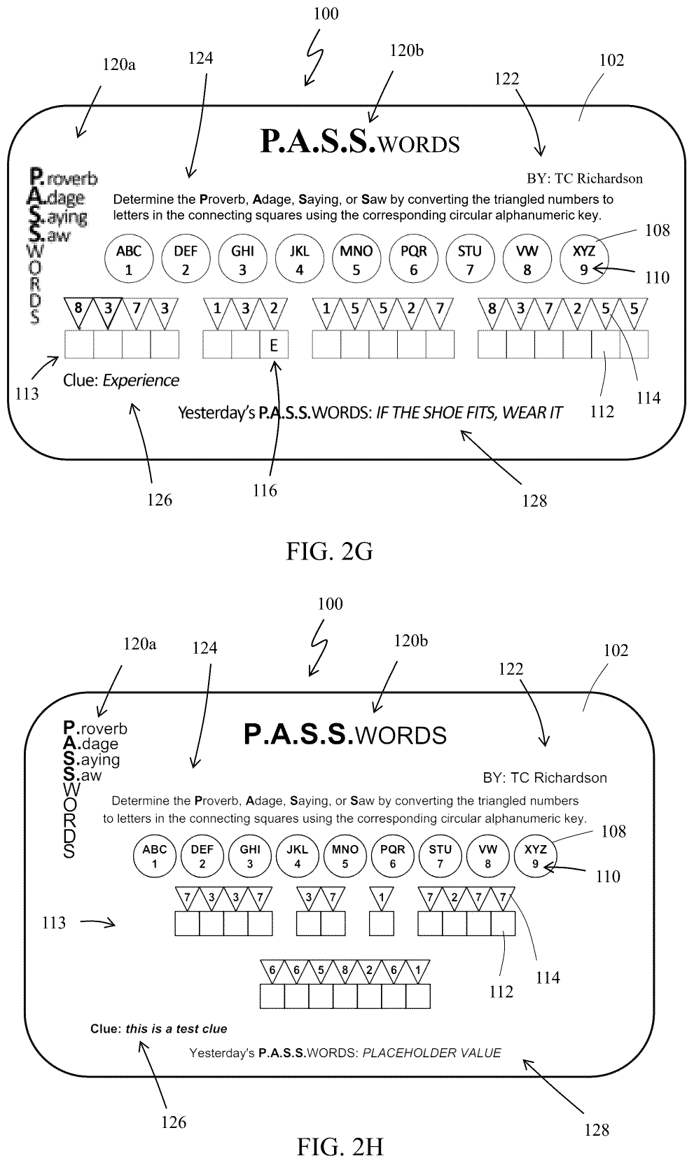

In some aspects, a solution to the puzzle 100 is achieved when the puzzle solver has entered a correct letter into each character-answer slot 112 of the string 113, as described herein. In some aspects, reading the string 113 of the solution to the puzzle 100 will reveal to the puzzle solver a proverb, an adage, a saying, or a saw. In some arrangements, the puzzle-solution field 106 can include a plurality of strings 113 stacked vertically relative to one another to indicate the puzzle solution contains multiple lines of text. For example, the puzzle 100 depicted in FIG. 1 has two strings 113 stacked vertically relative to one another, with each string 113 containing three words, indicating the puzzle's solution will be a six-word phrase (e.g., a six-word proverb, a six-word adage, a six-word saying, a six-word saw). In some arrangements, the puzzle-solution field 106 can have a string 113 that is displayed on one line only (see, e.g., FIG. 2A), which may occur, for example, when the solution to the puzzle 100 is a proverb, adage, saying or saw that has only a few words or characters in it.

FIG. 1 further illustrates that the puzzle-solution field 106 can include a plurality of indicator icons 114. In some aspects, the indicator icon 114 can indicate (e.g., through the pool identifier 110) which letter pool 108 the puzzle solver is to select a letter from for entering a character into the answer slot 112 associated with the indicator icon 114. For example, if an answer slot 112 in a string 113 is associated with an indicator icon 114 that is shaped like a star, and one of the letter pools 108 in the puzzle-key field 104 has a pool identifier 110 that is star-shaped, then the appropriate character for the answer slot 112 must appear in the letter pool 108 that is associated with the star-shaped pool identifier 110.

In some arrangements, the plurality of indicator icons 114 can be aligned one-to-one vertically with the plurality of answer slots 112, as shown in FIG. 1. In some arrangements, the number of indicator icons 114 can be reduced compared to the number of answer slots 112 such that one or more individual answer slots 112 does not have an indicator icon 114 associated with the individual answer slot 112. In some aspects, the difficulty of the puzzle 100 can be increased by removing an indicator icon 114 for one or more answer slots 112 such that the puzzle solver has less information and more possibilities to consider. In some aspects, the difficulty of the puzzle can be increased by using an indicator icon 114 that indicates the correct letter for the corresponding answer slot 112 is among a group of more than one letter pools 108 (e.g., two, three, four). In some arrangements, the pool identifier 110 can be a one-character identifier (e.g., a text character or number) and the indicator icon 114 can be that corresponding text character or number. In other words, the indicator icon 114 need not include a geometric shape such as the triangle-shaped icon that is depicted in FIG. 1 to represent the indicator icon 114. In some aspects the indicator icon 114 can be a geometric shape without a text character or number. For example, the letter pools 108 can be distinguished from one another by a pool identifier 110 that has a particular geometric shape (e.g., triangle, diamond, square, star, arrow, circle, pentagon, hexagon, polygon) and identification of the corresponding indicator icon 114 can be established by using that same particular geometric shape.

In some arrangements, the puzzle 100 can provide the puzzle solver a given letter 116 by pre-filling one or more answer slots 112 with the correct letter for the solution of the puzzle 100. For example, in FIG. 1 the given letter 116 is “Y” and it is pre-filled into the last answer slot 112 of the string 113 that appears on the top line of the puzzle-solution field 106. In some arrangements, the difficulty of the puzzle 100 can be customized by providing one or more given letter 116. Alternatively and additionally, the difficulty of the puzzle 100 can be customized by selecting which answer slot 112 to fill in with the given letter 116. As can be appreciated, knowing certain letters of a word can be more helpful to resolving the identity of the word compared to knowing other letters of the word.

FIG. 1 further illustrates that the puzzle 100 can include additional fields to provide information to the puzzle solver. For example, the puzzle 100 can include a title field 120, an author field 122, an instructions field 124, a clue field 126, and a history field 128. In some aspects, the title field 120 can include the display of a source-identifier or a brand of the puzzle 100. In some aspects, the title field 120 can display text or iconographic information that informs a puzzle solver about the quality, difficulty, or nature of the puzzle 100. The author field 122 can include the name of the person who authored or created a particular version of the puzzle 100. The instructions field 124 can provide instructions to the puzzle solver regarding the rules or solution-method of the puzzle 100. The clue field 126 can provide a hint that is designed to help guide the puzzle solver to the desired solution of the puzzle 100. The clue field 126 can allow customization of the difficulty of the puzzle 100 by providing a more straightforward clue to decrease difficulty of the puzzle 100 or by providing a more cryptic clue to increase difficulty of the puzzle. The history field 128 can provide the solution to an earlier-published puzzle 100. For example, in a periodical publication, the history field 128 can provide the solution to the puzzle 100 that was published in the preceding publication of the periodical. A puzzle 100 that appears in a daily newspaper, for example, can have a history field 128 that informs the puzzle-solver of the solution to a puzzle 100 that appeared in the newspaper on the immediately preceding day.

FIG. 2A depicts an illustrative, non-limiting example of a pooled-letter word puzzle 100, according to some aspects of the present disclosure. In the depicted arrangement of the puzzle 100 of FIG. 2A, the puzzle-key field 104 shows nine letter pools 108, with each letter pool 108 identified uniquely by a pool identifier 110 that is a numeral from “1” to “9”. The letters of the alphabet are distributed, in alphabetical order, across the letter pools 108, with each letter pool 108 having three letters except for the letter pool 108 identified by the pool identifier 110 that is the numeral “8”; that letter pool 108 contains only two letters: “V” and “W”. However, as described herein, in some aspects, the puzzle 100 can be configured to have a number of letter pools 108 that is different from nine (e.g., eight, ten, seven, six, five) or the letters of the alphabet can be distributed differently among nine letter pools 108 (e.g., in non-alphabetic order). In some aspects, the difficulty of the puzzle 100 can be customized by altering the distribution of the letters of the alphabet among the letter pools 108. For example, the difficulty of the puzzle 100 depicted in FIG. 2A could be increased by switching “U” with “W” such that the letter pool 108 labeled with “7” as its pool identifier 110 would now refer to the group of the three letters “S”, “T”, and “W”, while the letter pool 108 labeled with “8” as its pool identifier 110 would now refer to the group of two letters “U” and “V”. This would likely make the puzzle 100 more difficult to solve because, before the letter swap, the pool identifier 110 of the first and last words of the solution was “8” and indicated the correct letter was one of two letters, namely, either “W” or “V”, whereas after the letter swap, the pool identifier 110 of the first and last words of the solution would now be “7” and indicate the correct letter is one of three letter, namely, either “S”, “T”, or “W”.

The puzzle 100 depicted in FIG. 2A includes a given letter 116, which is illustrated by the letter “E” pre-filled into the last answer slot 112 of the second word of the solution phrase. In some aspects, the given letter 116 can provide a means to customize the difficulty of the puzzle 100. For example, the difficulty of the puzzle 100 can be increased in some aspects by not providing the puzzle solver with any given letter 116. On the other hand, the difficulty of the puzzle 100 would likely be reduced by providing the given letter 116 “G” in the slot immediately preceding the given letter 116 “E” in FIG. 2A rather than providing the depicted given letter 116 “E”. This is because the second word of the solution of the puzzle 100 is “AGE”. The puzzle solver is likely to be helped more knowing the second letter is “G” rather than knowing the third letter is “E” because more three-letter words have “E” in the final letter position compared to the number of three-letter words that have a “G” in the second letter position. Also, once “G” is known to be the second letter of the second word, the puzzle solver can quickly determine “A” is likely the first letter of the word given that pool identifier 110 of “1” makes “B” and “C” the only other alternatives to “A”, and a three-letter word starting with “AG” is much more likely to be correct compared to a three-letter word starting with “BG” or “CG”.

FIG. 2A further illustrates that in some aspects, the puzzle 100 can have an over-arching theme that is reinforced by the various display fields of the puzzle 100. For example, the title field 120 in FIG. 2A reads “P.A.S.S.WORDS”, with the abbreviation reinforcing the theme of puzzle 100 that the solution will be a Proverb, Adage, Saying, or Saw (P.A.S.S.). Further, the remaining portion of the title field 120 (i.e., “WORDS”) reinforces to the puzzle solver that the solution to the puzzle 100 will be words. Still further, the letter pools 108 in FIG. 2A appear as round, numbered buttons, suggesting to the puzzle solver that a code or password must be typed into the answer slots to unlock the puzzle 100 and reveal a treasure (i.e., a proverb, adage, saying or saw).

FIG. 2B depicts an illustrative, non-limiting example of a pooled-letter word puzzle 100, according to some aspects of the present disclosure. In some aspects, the difficulty of the puzzle 100 can be increased by using a clue 126 that is more obscure with regard to the solution of the puzzle 100. For example, in FIG. 2B the clue 126 is the word “Experience”, which is a somewhat obscure reference to the solution of the puzzle 100 (i.e., “WITH AGE COMES WISDOM”) compared with the clue 126 in FIG. 2A, which is the phrase “ . . . Before Beauty”, suggesting the word “age”, one of the words of the solution of the puzzle, making the clue 126 in the puzzle 100 of FIG. 2A more directly related to the solution of the puzzle 100 and therefore making the difficulty of the puzzle 100 of FIG. 2A less than the difficulty of the puzzle 100 of FIG. 2B. In some aspects, the difficulty of the puzzle 100 can be reduced by providing a clue 126 that refers to a word for which a given letter 116 has been provided. For example, in FIG. 2A the clue 126 suggests the word “age”, for which the given letter 116 “E” has been provided.

FIG. 2C depicts an illustrative, non-limiting example of a pooled-letter word puzzle 100, according to some aspects of the present disclosure. In some aspects, the title filed 120 can be oriented vertically to assist the puzzle solver recall that the solution of the puzzle 100 will be words that reveal a passage, an adage, a saying, or a saw. In some aspects, the title field 120 can include different styles of fonts to help the puzzle solver distinguish between the vertically-oriented words of the title field 120. For example, in FIG. 2C, portions of the vertically-oriented words “adage” and “saw” are displayed in a lighter-gray font to distinguish these second and fourth vertically-oriented words of the title field 120 from the first and third vertically-oriented words of the title field 120. FIG. 2C also illustrates that in some aspects the difficulty of the puzzle 100 can be increased by providing only empty answer slots 112. In other words, the difficulty of the puzzle 100 can be increased by not providing a given letter 116 (FIG. 2B) in any of the answer slots 112.

FIG. 2D illustrates a puzzle 100 similar to the puzzle 100 of FIG. 2C except as differently described herein. As shown in FIG. 2D, the title field 120 can include periods between the first letters of the vertically-oriented words of the title field 120 to assist the puzzle solver distinguish adjacent vertically-oriented words from one another. FIG. 2D illustrates that in some aspects the difficulty of the puzzle 100 can be decreased by pre-filling at least one given letter 116 into an answer slot 112, as described herein.

FIG. 2E depicts an illustrative, non-limiting example of a pooled-letter word puzzle 100, according to some aspects of the present disclosure. In some aspects, the title filed 120 can be a collection of horizontally-oriented words that each features a prominent first letter such that the collection of vertically-oriented first letters of the horizontally-oriented words forms a word or portion of a word itself. For example, in the puzzle 100 of FIG. 2E, the title field 120 features four horizontally-oriented words (Proverb, Adage, Saying, Saw) that each has a prominent first letter (i.e., P, A, S, S) which form a portion of the vertically-oriented word “PASSWORDS”. The configuration of the title field 120 of FIG. 2E can assist the puzzle solver recall that the solution to the puzzle 100 will be a proverb, adage, saying or saw. In some aspects, the title field 120 can include different styles of fonts to help the puzzle solver distinguish between the horizontally-oriented words of the title field 120 and the vertically-oriented word formed therein, as shown in FIG. 2E, with the first letter of the horizontally-oriented words being bold, capitalized, and larger font size compared with the remaining letters of the horizontally-oriented words.

FIG. 2F illustrates a puzzle 100 similar to the puzzle 100 of FIG. 2E except as differently described herein. As shown in FIG. 2F, the title field 120 can include periods between the first letters of the horizontally-oriented words of the title field 120 and the remaining letters of the horizontally-oriented words to assist the puzzle solver to distinguish the vertically-oriented word portion (i.e., PASS) that is formed by the collection of the first letter letters of the horizontally-oriented words (i.e., proverb, adage, saying, saw). FIG. 2F further illustrates that additional vertically-oriented letters can be aligned-vertically underneath the vertically-oriented first letters of the horizontally-oriented words to form a larger word. For example, in the puzzle 100 of FIG. 2F, the letters “W”, “O”, “R”, “D”, and “S” are vertically-aligned underneath the collection of the first letters of the horizontally-oriented words (i.e., “PASS”), thereby forming the vertically-oriented word: “PASSWORDS”. In some aspects, the title field 120 can use a different font style or size to distinguish characters of the vertically-aligned word that are associated with a horizontally-aligned word from characters of the vertically-aligned word that are not associated with a horizontally-aligned word. For example, in FIG. 2F, the letters “P”, “A”, “S”, and “S” (which are each associated with a horizontally-aligned word) appear in bold and larger font compared to the remaining letters “WORDS” (which are not associated with a horizontally-aligned word).

FIG. 2G depicts an illustrative, non-limiting example of a pooled-letter word puzzle 100, according to some aspects of the present disclosure. In some aspects, the title filed 120 can include both a vertically-oriented title portion 120a and a horizontally-oriented title portion 120b. In some aspects, the vertically-oriented title portion 120a and the horizontally-oriented title portion 120b can work together to succinctly inform the puzzle solver about the nature of the puzzle 100. For example, in the puzzle 100 of FIG. 2G, the vertically-oriented portion 120a is configured to remind the puzzle solver that the solution to the puzzle 100 will be a proverb, adage, saying, or saw, while the horizontally-oriented portion 120b is configured to convey this similar information through a brand or source-identifier of the puzzle 100 that prominently and succinctly represents the information conveyed to the puzzle solver by the vertically-oriented portion 120a. FIG. 2G further illustrates that the horizontally-oriented title portion 120b can be superior vertically to the author field 122. In some configurations, the author field 122 can be in-line vertically with the horizontally-oriented title portion 120b.

FIG. 2H illustrates a puzzle 100 similar to the puzzle 100 of FIG. 2G except as differently described herein. As shown in FIG. 2H, the answer string 113 can extend over multiple vertical lines of text. For example, FIG. 2H shows a string 113 that extends over two lines of text, the first line have four words and the second line having only one word. Therefore, the answer to the puzzle 100 of FIG. 2H will be a five-word proverb, adage, saying or saw.

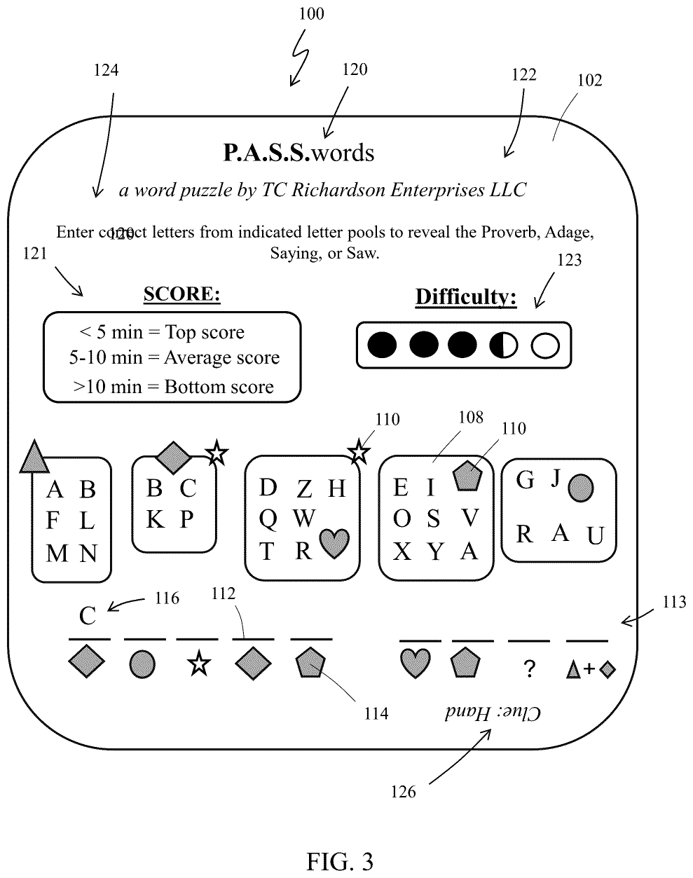

FIG. 3 depicts an illustrative, non-limiting example of a pooled-letter word puzzle 100, according to some aspects of the present disclosure. FIG. 3 illustrates that the puzzle 100 can have one or more letters appear in more than one letter pool 108. For example, in the puzzle 100 of FIG. 3, the letter “B” appears in the left-most letter pool 108, which has a triangle-shaped pool identifier 110, and also appears in the immediately adjacent letter pool 108, which has a diamond-shaped pool identifier 110. FIG. 3 illustrates that some letter pools 108 can be identified by an identical pool identifier 110. For example, the puzzle of FIG. 3 has a star-shaped pool identifier 110 that is associated with each of the middle letter pool 108 (which is also associated with a heart-shaped pool identifier 110) and the letter pool 108 immediately adjacent to the left of this letter pool 108 (which is also associated with a diamond-shaped pool identifier 110). As can be appreciated from FIG. 3, the difficulty of the puzzle 100 can be increased by using indicator icons 114 and pool identifiers 110 that refer more ambiguously to the correct letter pool 108 from which to select the character to enter into the answer slot 112. For example, the third answer slot 112 from the left has an indicator icon 114 that references a star-shaped pool identifier 110 that is associated with two letter pools 108. The difficulty of the puzzle 100 could be decreased by replacing the ambiguous star-shaped pool identifier 110 that references two letter pools 108 (heart and diamond) with a pool identifier 100 that references only the correct letter pool 108 (heart).

In some arrangements, the difficulty of the puzzle 100 can be increased by using an indicator icon 114 that does not reveal any information about which letter pool 108 the puzzle solver is to select the correct character for the answer slot 112. For example, the puzzle 100 in FIG. 3 has for the second to last answer slot 112 an indicator icon 114 that is a question mark, indicating that the puzzle solver will not be provided any information regarding which letter pool 108 contains the correct character for that answer slot 112. The last answer slot 112 in the puzzle 100 of FIG. 3 illustrates that the indicator icon 114 can include a combination of pool identifiers 110 (e.g., triangle and diamond) to indicate that the correct letter for that answer slot 112 is contained within the letter set formed by the union of the letter pools 108 indicated by the combination of pool identifiers 110. In some arrangements, the indicator icon 114 can use notation (e.g., a subtraction sign rather than an addition sign) to indicate the correct letter for the answer slot 112 is contained within the letter set formed by the intersection of the letter pools 108.

FIG. 3 further illustrates that the author field 122 can operate in conjunction with the title field 120 to inform the puzzle solver the source of the puzzle 100. For example, the puzzle 100 in FIG. 3 has a title field 120 that displays a brand or source-identifier (i.e., “P.A.S.S.words”) and an author field 122 that further informs the puzzle solver that the brand or source indicated in the title field 120 is owned by a particular company (i.e., “TC Richardson Enterprises LLC”) or individual who is responsible for maintaining the goodwill or quality of the word puzzles bearing that brand or source-identifier. FIG. 3 also illustrates that in some arrangements the clue field 126 can display the clue inverted so that the puzzle solver can attempt to solve the puzzle 100 without the assistance of the clue.

FIG. 3 further illustrates that the puzzle 100 can have a score field 121 that provides the puzzle solver with a method of scoring the puzzle solver's performance for solving the puzzle. For example, the score field 121 of FIG. 3 allows the puzzle solver a way to evaluate the puzzle solver's performance based on how long it took the puzzle solver to solve the puzzle. In some aspects, the puzzle 100 can include a difficulty field 123 that displays a difficulty rating for the puzzle that indicates the difficulty of solving the puzzle 100. For example, the difficulty field 123 of FIG. 3 includes a row of three filled in circle, one half-filled circle, and one unfilled circle, indicating iconically that the puzzle 100 has a difficulty rating of 3.5/5.0.

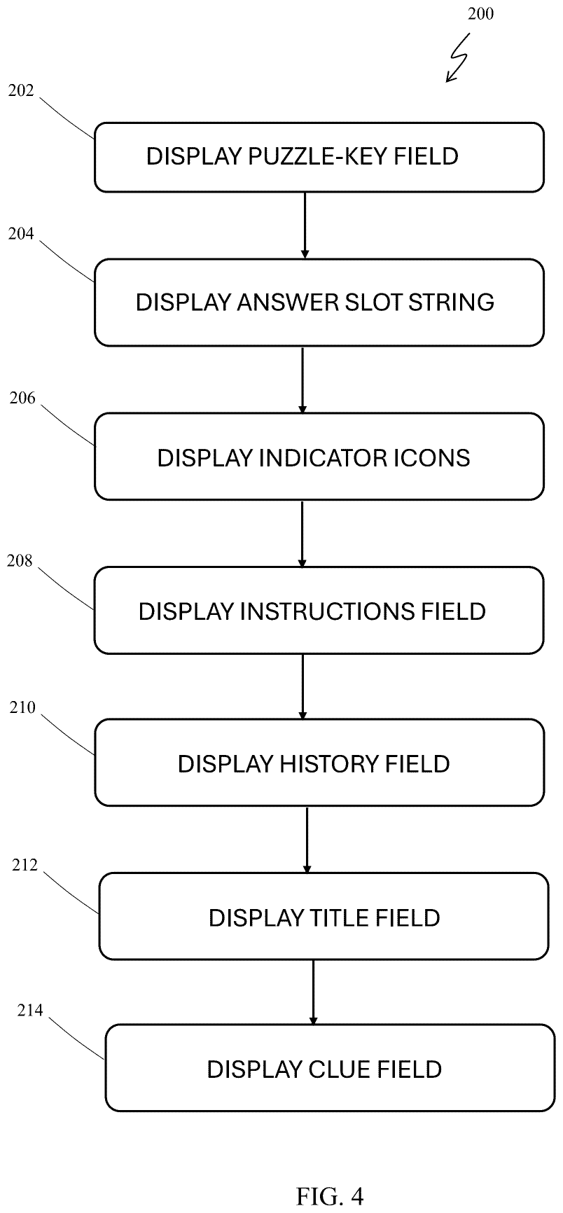

FIG. 4 depicts an illustrative, non-limiting example of a method 200 of displaying a pooled-letter word puzzle 100, according to some aspects of the present disclosure. In some arrangements, the method 200 of displaying the puzzle 100 can include a displaying-a-puzzle-key-field step 202 in which the puzzle key 106 is displayed to a display tableau 102, as described herein. In some aspects, the method 200 of displaying the puzzle 100 can include a displaying-an-answer-string step 204 in which the string 113 of answer slots 112 is displayed to a display tableau 102, as described herein. In some variants, the method 200 of displaying the puzzle 100 can include a displaying-indicator-icons step 206 in which one or more indicator icons 114 are displayed to a display tableau 102 to assist the puzzle solver deduce the identity of the correct alphabetic character to enter for the answer slot 112 that is associated with each of the displayed indicator icons 114, as described herein. In some aspects, the method 200 of displaying the puzzle 100 can include a displaying-instructions step 208 in which the instructions field 124 is displayed to a display tableau 102, as described herein. In some aspects, the method 200 of displaying the puzzle 100 can include a displaying-history step 210 in which the history field 128 is displayed to a display tableau 102, as described herein. In some aspects, the method 200 of displaying the puzzle 100 can include a displaying-title step 212 in which the title field 120 is displayed to a display tableau 102, as described herein. In some aspects, the method 200 of displaying the puzzle 100 can include a displaying-clue step 214 in which the clue field 126 is displayed to a display tableau 102, as described herein.

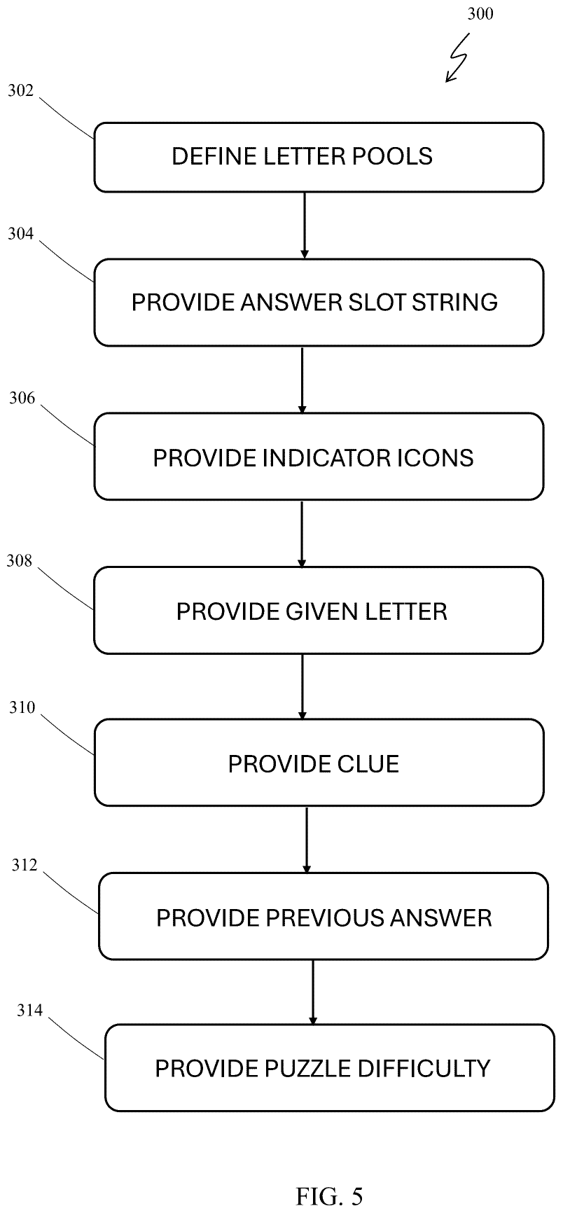

FIG. 5 depicts an illustrative, non-limiting example of a method 300 of creating a pooled-letter word puzzle 100, according to some aspects of the present disclosure. In some arrangements, the method 300 of creating the puzzle 100 can include a defining-letter-pools step 302 in which each alphabetic character is assigned to one or more letter pools 108, as described herein. In some aspects, the method 300 of creating the puzzle 100 can include a providing-answer-slots step 304 in which the string 113 of answer slots 112 is displayed to a display tableau 102, as described herein. In some variants, the method 300 of creating the puzzle 100 can include a providing-indicators step 306 in which one or more indicator icons 114 are displayed to a display tableau 102 to assist the puzzle solver deduce the identity of the correct alphabetic character to enter for the answer slot 112 that is associated with each of the displayed indicator icons 114, as described herein. In some aspects, the method 300 of creating the puzzle 100 can include a providing-given-letters step 308 in which one or more given letters 116 is displayed to a display tableau 102, as described herein. In some aspects, the method 300 of creating the puzzle 100 can include a providing-clue step 310 in which clue field 126 is displayed to a display tableau 102, as described herein. In some aspects, the method 300 of creating the puzzle 100 can include a providing-history step 312 in which the history field 128 is displayed to a display tableau 102, as described herein. In some aspects, the method 300 of creating the puzzle 100 can include a rating-difficulty step 314 in which the difficulty field 123 is displayed to a display tableau 102, as described herein.

### Other Variations and Terminology

While certain embodiments have been described, these embodiments have been presented by way of example only and are not intended to limit the scope of protection. Indeed, the novel methods and systems described herein may be embodied in a variety of other forms. It will be understood by those skilled in the art that the present disclosure extends beyond the specifically disclosed embodiments to other alternative embodiments or uses and obvious modifications and equivalents thereof, including embodiments which do not provide all of the features and advantages set forth herein. Furthermore, various omissions, substitutions, and changes in the form of the methods and systems described herein may be made. Those skilled in the art will appreciate that in some embodiments, the actual steps taken in the processes illustrated or disclosed may differ from those shown in the figures. Depending on the embodiment, certain of the steps described above may be removed; others may be added. Accordingly, the scope of the present disclosure is not intended to be limited by the specific disclosures of preferred embodiments herein and may be defined by claims as presented herein or as presented in the future. The language of the claims is to be interpreted broadly based on the language employed in the claims and not limited to the examples described in the patent specification of during prosecution of the application, which examples are to be construed as non-exclusive.

Features, materials, characteristics, or groups described in conjunction with a particular aspect, embodiment, or example are to be understood to be applicable to any other aspect, embodiment, or example described herein unless incompatible therewith. All of the features disclosed in this specification (including any accompanying claims, abstract, and drawings), or all of the steps of any method or process so disclosed, may be combined in any combination, except combinations where at least some of such features or steps are mutually exclusive. The protection extends to any novel one, or any novel combination, of the features disclosed in this specification (including any accompanying claims, abstract, and drawings), or to any novel one, or any novel combination, of the steps of any method or process so disclosed.

Conditional language, such as “can,” “could,” “might,” or “may,” unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of the stated amount. As another example, the terms “generally parallel” and “substantially parallel” may refer to a value, amount, or characteristic that departs from exactly parallel by less than 15 degrees.

What is claimed is:

1. A word puzzle comprising:
a display tableau;
a puzzle-key field displayed on the display tableau, the puzzle-key field comprising a plurality of letter pools, each letter pool being identified by an indicator icon, each letter pool comprising a letter set of at least one alphabetic letter;
a puzzle-solution field comprising a plurality of answer slots, the plurality of answer slots aligned horizontally to form a string; and
a plurality of indicator icons, each indicator icon associated with a one answer slot, each indicator icon indicating for the one answer slot the letter pool from which to select a correct letter for the one answer slot.

2. The word puzzle of claim 1, wherein the display tableau is made of a paper, and each of the puzzle-key field and the puzzle-solution field is displayed on the display tableau by printing each of the puzzle-key field and the puzzle-solution field on the paper.

3. The word puzzle of claim 2, wherein the paper is a portion of a printed publication selected from the group consisting of: a newspaper, a magazine, a restaurant menu.

4. The word puzzle of claim 1, wherein the display tableau is a computer display screen, and each of the puzzle-key field and the puzzle-solution field is displayed on the display tableau by illuminating the computer display screen to render an image of each of the puzzle-key field and the puzzle-solution field onto the computer display screen.

5. The word puzzle of claim 1, further comprising a title field displayed on the display tableau, the title field disposed on the display tableau vertically superior to each of the puzzle-key field and the puzzle-solution field.

6. The word puzzle of claim 1, further comprising a given-letter character displayed on a given-letter answer slot of the plurality of answer slots.

7. The word puzzle of claim 1, further comprising a clue field displayed on the display tableau, the clue field comprising one or more words configured to indicate a solution to the word puzzle.

8. The word puzzle of claim 1, further comprising a history field displayed on the display tableau, the history field indicating a previous solution to a previous puzzle.

9. The word puzzle of claim 1, wherein at least one answer slot is not associated with an indicator icon.

10. The word puzzle of claim 1, wherein at least one indicator icon refers to more than one letter pool.

11. A method of displaying a word puzzle, the method comprising:
displaying on a display tableau a puzzle-key field comprising a plurality of letter pools, each letter pool being identified by an indicator icon, each letter pool comprising a letter set of at least one alphabetic letter;
displaying on the display tableau a puzzle-solution field comprising a plurality of answer slots, the plurality of answer slots aligned horizontally to form a string;
displaying on the display tableau a plurality of indicator icons, each indicator icon associated with a one answer slot, each indicator icon indicating for the one answer slot the letter pool from which to select a correct letter for the one answer slot.

12. The method of claim 11, wherein displaying on the display tableau comprises printing the puzzle-key field with an ink onto a paper.

13. The method of claim 11, wherein displaying on the display tableau comprises illuminating a computer display screen to render an image of the puzzle-key field onto the computer display screen.

14. The method of claim 11, wherein the indicator icons are displayed on the display tableau vertically superior to the answer slots.

15. The method of claim 11, wherein the indicator icons are displayed on the display tableau vertically inferior to the answer slots.

16. The method of claim 11, further comprising:
displaying on the display tableau a title field, the title field being vertically superior to each of the puzzle-key field and the puzzle-solution field.

17. The method of claim 16, wherein the title field comprises an abbreviation displayed on a far-left side of the title field and the abbreviation is a grouping of four letters: “P.A.S.S.”.

18. A method of creating a word puzzle, the method comprising:
defining a plurality of letter pools, each letter pool being identified by an indicator icon, each letter pool comprising a letter set of at least two alphabetic letters;
providing a puzzle-solution field comprising a plurality of answer slots and one or more blank spaces to form a string of words;
associating with each answer slot an appropriate indicator icon, wherein the appropriate indicator icon for each answer slot is the indicator icon that indicates the letter pool containing a correct alphabetic character for the answer slot.

19. The method of claim 18, wherein the string of words is a proverb, an adage, a saying, or a saw.
